(19) United States
(12) Patent Application Publication
(10) Pub. No.: US 2018/0101038 A1
(43) Pub. Date: Apr. 12, 2018

(54) METHOD OF ADJUSTING LIQUID CRYSTAL PANEL SIZE

(71) Applicant: Shenzhen China Star Optoelectronics Technology Co., Ltd., Shenzhen, Guangdong (CN)

(72) Inventors: Jie CHEN, Shenzhen, Guangdong (CN); Shih-ying SUN, Shenzhen, Guangdong (CN)

(73) Assignee: Shenzhen China Star Optoelectronics Technology Co., Ltd., Shenzhen, Guangdong (CN)

(21) Appl. No.: 15/106,882

(22) PCT Filed: Apr. 29, 2016
(86) PCT No.: PCT/CN2016/080810

§ 371 Date: Jun. 21, 2016

(30) Foreign Application Priority Data
Mar. 28, 2016 (CN) 201610182309.6

(51) Int. Cl. G02F 1/1339; G02F 1/1333

(52) U.S. Cl. CPC G02F 1/1339; G02F 2001/133331; G02F 1/133351; G02F 1/133308

(57) ABSTRACT

The present application discloses a method of adjusting a liquid crystal panel size. The liquid crystal panel includes a color filter substrate, an array substrate and liquid crystal filled between the two. The method of adjusting the liquid crystal panel size includes steps of: cutting the liquid crystal panel to form a fracture at a cutting position; coating adhesive at the fracture; making the adhesive partially or fully permeate between the color filter layer and the array substrate; solidifying the adhesive. The present application does not press the liquid crystal substrate, and no risk of damaging the liquid crystal substrate exists. Coating the adhesive is easy for operation, and the coating success ratio is high and the production efficiency is high.

### CROSS REFERENCE

This application claims the priority of Chinese Patent Application No. 201610182309.6, entitled “Method of adjusting liquid crystal panel size”, filed on Mar. 28, 2016, the disclosure of which is incorporated herein by reference in its entirety.

### FIELD OF THE INVENTION

The present application relates to a display technology field, and more particularly to a method of adjusting a liquid crystal panel size.

### BACKGROUND OF THE INVENTION

The display is usually to show the text or the image. In all the specific applications, the specific performance properties of the liquid crystal panels are necessary. Because the change made for satisfying the special application of the liquid crystal panel alone will greatly raise the manufacture cost, and from the economy to consider, the maker provides the universal design solution in the mass production so that all the liquid crystal panel have the properties which are basically the same and the physical dimensions of limited amounts, and then it is cut and becomes the liquid crystal panel of the required size, and the adhesive is coated to accomplish the manufacture.

In prior art, the finish of coating the adhesive is mainly to freeze the liquid crystal inside the panel. With the principle of thermal expansion and contraction, the drain of the liquid crystal is avoided, and then the adhesive is coated, and it has extremely high requirement for the coating, and the issues of abnormal coating of the adhesive or the lower yield, and even the issue that the bubble is mixed into the display can easily happen; the other way is to press the fracture of the substrate with the external component and then the adhesive is coated but this method has the risk of crushing the panel.

### SUMMARY OF THE INVENTION

An objective of the present application is to provide a method of adjusting a liquid crystal panel size, for solving the issues that the adhesive coating difficulty is high, and the coating efficiency is low, and the success ratio is low, and even the risk of pressing the liquid crystal panel exists.

For solving the aforesaid technical issue, the present application provides a method of adjusting a liquid crystal panel size, and the liquid crystal panel comprises a color filter substrate, an array substrate and liquid crystal filled between the two, wherein the method of adjusting the liquid crystal panel size comprises steps of:

cutting the liquid crystal panel to form a fracture at a cutting position;

coating adhesive at the fracture;

making the adhesive partially or fully permeate between the color filter layer and the array substrate;

solidifying the adhesive.

Furthermore, the step of making the adhesive partially or fully permeate between the color filter layer and the array substrate comprises: vertically locating the liquid crystal panel after being cut, and maintaining the fracture face up, and the adhesive partially or fully permeates between the color filter layer and the array substrate with syphonage.

Furthermore, the step of making the adhesive partially or fully permeate between the color filter layer and the array substrate comprises: vertically locating the liquid crystal panel after being cut, and maintaining the fracture face up, and the adhesive partially or fully permeates between the color filter layer and the array substrate with gravity.

Furthermore, the step of making the adhesive partially or fully permeate between the color filter layer and the array substrate comprises: providing a pressure device, and inserting a part where the fracture of the liquid crystal panel after being cut is into a pressure cavity of the pressure device, and making the adhesive partially or fully permeate between the color filter layer and the array substrate with pressure.

Furthermore, the pressure device comprises the pressure cavity, a vacuum pump and a vacuum valve connected between the pressure cavity and the vacuum pump, and opening the vacuum valve in the pressure process, and the vacuum pump pumps gas into the pressure cavity.

Furthermore, a gas pressure value in the pressure cavity at least is a standard atmospheric pressure.

Furthermore, the part where the fracture of the liquid crystal panel is is inserted into the pressure cavity with 1 mm-5 mm.

Furthermore, the adhesive is light curing adhesive.

Furthermore, the adhesive is heat curing adhesive.

Furthermore, the adhesive is light and heat curing adhesive.

The benefits of the present application are: the method does not press the liquid crystal substrate, and no risk of damaging the liquid crystal substrate exists; coating the adhesive is easy for operation, and the coating success ratio is high and the production efficiency is high.

### BRIEF DESCRIPTION OF THE DRAWINGS

In order to more clearly illustrate the embodiments of the present application or prior art, the following figures will be described in the embodiments are briefly introduced. It is obvious that the drawings are merely some embodiments of the present application, those of ordinary skill in this field can obtain other obvious variations according to these figures without paying the premise.

FIG. 1 is a structure diagram of a liquid crystal panel.

FIG. 2 is a flowchart of a method of adjusting a liquid crystal panel size provided by the first embodiment of the present application.

FIG. 3 is a structure diagram of a liquid crystal panel after being cut.

FIG. 4 is a diagram that the adhesive permeates into the liquid crystal panel with syphonage or gravity.

FIG. 5 is a flowchart of a method of adjusting a liquid crystal panel size provided by the second embodiment of the present application.

FIG. 6 is a structure diagram of a pressure device.

### DETAILED DESCRIPTION OF PREFERRED EMBODIMENTS

Embodiments of the present application are described in detail with the technical matters, structural features, achieved objects, and effects with reference to the accompanying drawings as follows. It is clear that the described embodiments are part of embodiments of the present application, but not all embodiments. Based on the embodiments of the present application, all other embodiments to those of ordinary skill in the premise of no creative efforts obtained, should all be considered within the scope of protection of the present application.

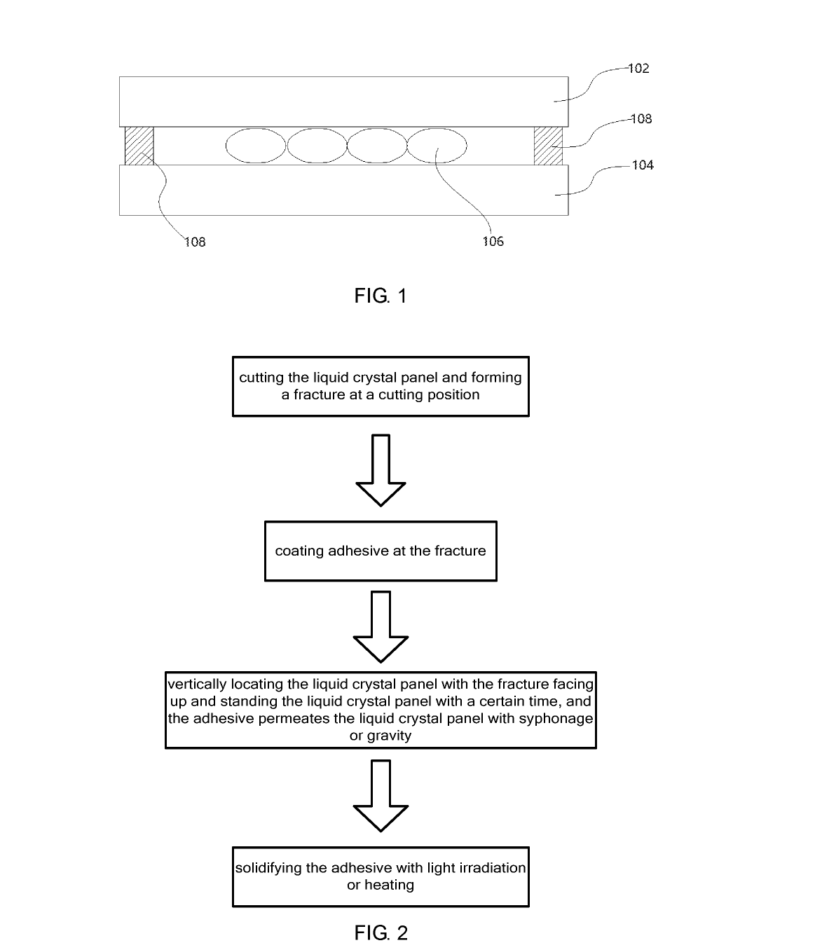

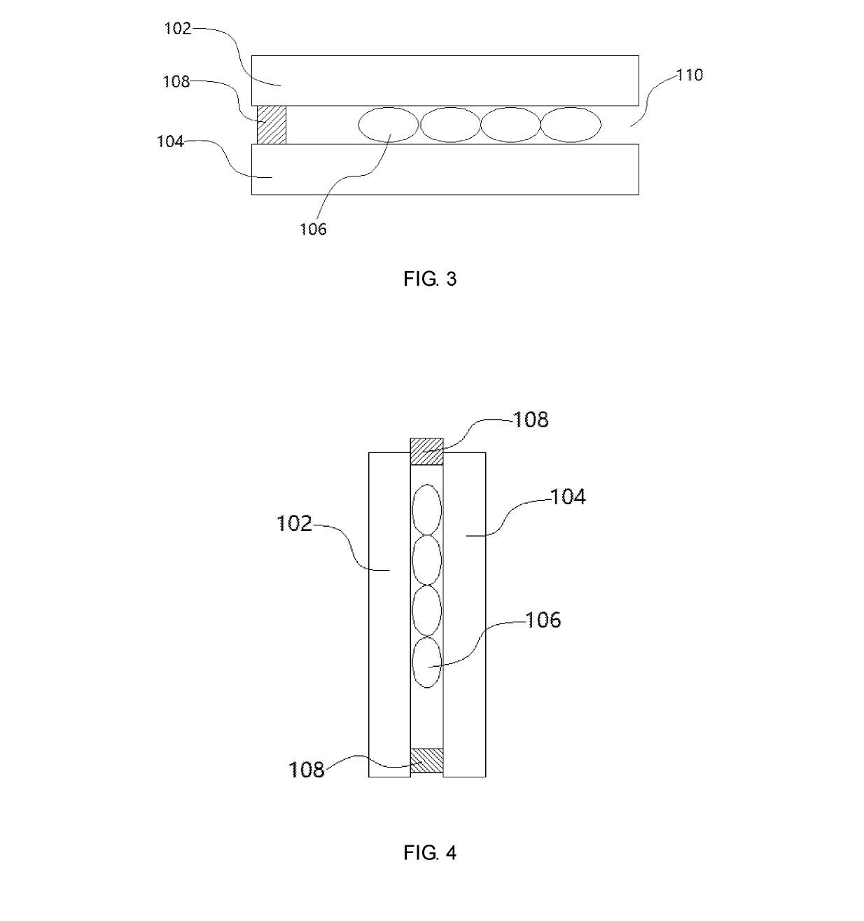

FIG. 1 is a structure diagram of a liquid crystal panel. As shown in figure, the liquid crystal panel comprises a color filter substrate 102, an array substrate 104 and liquid crystal 106 filled between the two. For fixing the color filter substrate 102 and the array substrate 104, and sealing the liquid crystal 106 inside the liquid crystal panel, it is required to coat adhesive 108.

With combination of FIG. 2 and FIG. 4, a method of adjusting a liquid crystal panel size provided by the first embodiment of the present application mainly comprises steps of:

step 1, cutting the liquid crystal panel, the color filter substrate 102 and the array substrate 104 to form a fracture 110 at a cutting position.

step 2, coating adhesive 108 at the fracture 110.

step 3, vertically locating the liquid crystal panel, and maintaining the fracture 110 coated with the adhesive 108 in the step 2 face up, and standing the liquid crystal panel, and a standing duration is determined according to a adhesive property.

step 4, solidifying the adhesive 108 coated on the fracture 110 with light irradiation, heating or light irradiation plus heating to accomplish adjusting the liquid crystal panel size.

The adhesive itself has certain fluidity. On one hand, due to the gravity of the adhesive 108 itself, the adhesive 108 permeates downward into the liquid crystal panel through the gap between the color filter substrate 102 and the array substrate 104; on the other hand, the adhesive 108 permeates between the color filter substrate 102 and the array substrate 104 with syphonage, and because the color filter substrate 102 and the array substrate 104 are adhered in vacuum condition, after the liquid crystal panel is cut and the adhesive 108 is coated on the fracture 110, the external pressure is far greater than the pressure inside the liquid crystal panel, and under the pressure difference inside and outside the liquid crystal panel, the adhesive 108 permeates downward into the liquid crystal panel through the gap between the color filter substrate 102 and the array substrate 104. The permeating volume of the adhesive 108 is relative to the viscosity of the adhesive and the pressure difference.

In the method of adjusting the liquid crystal panel size provided by the first embodiment of the present application, the operation is simple and easy, and the coating efficiency is high, and contacting the liquid crystal panel with an external device is not required, and no risk of damaging the liquid crystal substrate exists.

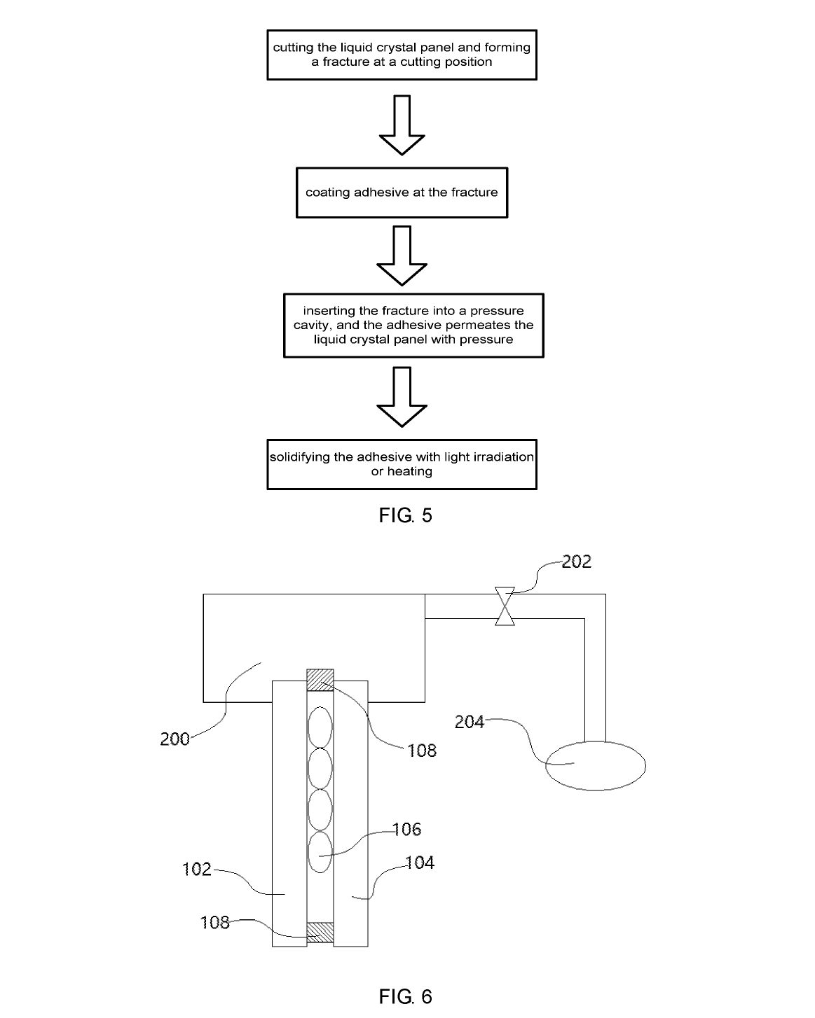

FIG. 5 is a flowchart of a method of adjusting a liquid crystal panel size provided by the second embodiment of the present application. As shows in figure, the method mainly comprises steps of:

step 1, cutting the liquid crystal panel, the color filter substrate 102 and the array substrate 104 to form a fracture 110 at a cutting position.

step 2, coating adhesive 108 at the fracture 110.

step 3, inserting the fracture 110 coated with the adhesive 108 into a pressure cavity 200 of the pressure device, and making the adhesive 108 partially or fully permeate between the color filter layer 102 and the array substrate 104 with pressure.

step 4, solidifying the adhesive 108 coated on the fracture 110 with light irradiation, heating or light irradiation plus heating to accomplish adjusting the liquid crystal panel size.

As shown in FIG. 6, the pressure device comprises a pressure cavity 200, a vacuum pump 202 and a vacuum valve 204. The vacuum valve 204 is connected between the pressure cavity 200 and the vacuum pump 202. The pressure process is first to insert the fracture 110 of the liquid crystal panel into the bottom of the pressure cavity 200 with 1mm-5mm, and the specific inserting value is determined according to the product design; the bottom of the pressure cavity 200 is closed, and the vacuum valve 202 is opened, and the vacuum pump 204 pumps the gas into the pressure cavity 200, and the pressure increases after the pressure cavity 200 is charged with the gas, and the gas charge pressure is larger than a standard atmospheric pressure, and the actual pressure is determined according to the material property of the adhesive 108; under pressure environment, the pressure acting on the fracture 110 is larger than the pressure inside the liquid crystal panel, and the adhesive 108 partially or fully permeates into the liquid crystal panel under the pressure difference; then, the vacuum valve 202 is closed, and the bottom of the pressure cavity 200 is opened to withdraw the liquid crystal panel.

In the method of adjusting the liquid crystal panel size provided by the second embodiment of the present application, the coating efficiency is high, and the impurity, such as bubble is hard to enter the liquid crystal panel, and the product yield is high and it is hard to damage the liquid crystal panel.

The adhesive used in the present application can be the light curing adhesive, the heat curing adhesive or the light and heat curing adhesive.

Above are embodiments of the present application, which does not limit the scope of the present application. Any modifications, equivalent replacements or improvements within the spirit and principles of the embodiment described above should be covered by the protected scope of the invention.

What is claimed is:

1. A method of adjusting a liquid crystal panel size, and the liquid crystal panel comprises a color filter substrate, an array substrate and liquid crystal filled between the two, wherein the method of adjusting the liquid crystal panel size comprises steps of:
cutting the liquid crystal panel to form a fracture at a cutting position;
coating adhesive at the fracture;
making the adhesive partially or fully permeate between the color filter layer and the array substrate;
solidifying the adhesive.

2. The method of adjusting the liquid crystal panel size according to claim 1, wherein the step of making the adhesive partially or fully permeate between the color filter layer and the array substrate comprises: vertically locating the liquid crystal panel after being cut, and maintaining the fracture face up, and the adhesive partially or fully permeates between the color filter layer and the array substrate with syphonage.

3. The method of adjusting the liquid crystal panel size according to claim 1, wherein the step of making the adhesive partially or fully permeate between the color filter layer and the array substrate comprises: vertically locating the liquid crystal panel after being cut, and maintaining the fracture face up, and the adhesive partially or fully permeates between the color filter layer and the array substrate with gravity.

4. The method of adjusting the liquid crystal panel size according to claim 1, wherein the step of making the adhesive partially or fully permeate between the color filter layer and the array substrate comprises: providing a pressure device, and inserting a part where the fracture of the liquid crystal panel after being cut is into a pressure cavity of the pressure device, and making the adhesive partially or fully permeate between the color filter layer and the array substrate with pressure.

5. The method of adjusting the liquid crystal panel size according to claim 4, wherein the pressure device comprises the pressure cavity, a vacuum pump and a vacuum valve connected between the pressure cavity and the vacuum pump, and the vacuum valve is opened in the pressure process, and the vacuum pump pumps gas into the pressure cavity.

6. The method of adjusting the liquid crystal panel size according to claim 4, wherein a gas pressure value in the pressure cavity at least is a standard atmospheric pressure.

7. The method of adjusting the liquid crystal panel size according to claim 4, wherein the part where the fracture of the liquid crystal panel is is inserted into the pressure cavity with 1 mm-5 mm.

8. The method of adjusting the liquid crystal panel size according to claim 1, wherein the adhesive is light curing adhesive.

9. The method of adjusting the liquid crystal panel size according to claim 1, wherein the adhesive is heat curing adhesive.

10. The method of adjusting the liquid crystal panel size according to claim 1, wherein the adhesive is light and heat curing adhesive.
